(19) United States
(12) Patent Application Publication
(10) Pub. No.: US 2022/0317145 A1
(43) Pub. Date: Oct. 6, 2022

(54) BLAST SENSING USING A KINEMATIC SENSOR

(71) Applicant: Prevent Biometrics, Inc., Edina, MN (US)

(72) Inventor: Adam Bartsch, Chaska, MN (US)

(21) Appl. No.: 17/709,765

(22) Filed: Mar. 31, 2022

Related U.S. Application Data
(60) Provisional application No. 63/170,217, filed on Apr. 2, 2021.

(51) Int. Cl. G01P 15/00; G01P 15/14

(52) U.S. Cl. CPC G01P 15/003; G01P 15/14; A63B 71/085

(57) ABSTRACT

A system for sensing and assessing blast events may include a sensing device configured for directly or indirectly securing to a user. The sensing device may include a kinematics sensor configured for sensing at least one of an acceleration and a velocity associated with an event and for generating kinematic signal data based on the event. The sensing device may also include a computer-readable storage medium having instructions stored thereon for receiving the kinematic signal data from the kinematic sensor and storing the kinematic signal data and a processor for processing the instructions to capture the kinematic signal data. The system may also include a computing device configured for analyzing the kinematic signal data to classify the event as a blast event or not a blast event. A method of assessing a blast event using the sensing system may also be provided.

### CLAIM OF PRIORITY

This patent application claims the benefit of priority to U.S. Application Ser. No. 63/170,217, filed Apr. 2, 2021, which is incorporated by reference herein in its entirety.

### TECHNOLOGICAL FIELD

The present disclosure relates to systems for sensing blast events. More particularly, the present disclosure relates to systems for determining the count and/or magnitude of one or more blast events. Still more particularly, the present disclosure relates to kinematic systems and methods for using the kinematic systems for monitoring blast events.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A blast wave is an area of pressure expanding supersonically outward from an explosive core. The change in pressure may develop over micro-seconds (e.g., 0.000001 sec). A blast wave can be defined mathematically by a pressure vs. time curve called a “Friedlander Waveform”. For the past 20 years efforts have been made to accurately measure this pressure-time waveform. Consistent with the pressure vs. time understanding of blast waves, blast gauges have been developed using a pressure membrane that vibrates in response to changing pressures. According to Col. Colin Greene, these gauges objectively do a terrible job as a diagnostic in military theater. (See Col. Colin Greene, “What is the Goal of a Sensor Program?”, p. 7, 2014 Dept. of Defense State of the Science Blast Mtg). For example, of 130 concussions diagnosed in service members, the blast gauge correctly identified only 9 of them. Id. This amounts to a sensitivity of 7%. Id.

In the laboratory this measurement is straightforward because the sensor environment can be controlled to avoid other interfering events. However, in the military context, it is exceedingly difficult to accurately and precisely measure pressure v. time because (1) the pressure sensors used are highly sensitive and (2) real-world blast waves have all kinds of constructive and destructive interference that provide omni-directional contamination to the true uni-directional wave of interest.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In one or more embodiments, a system for sensing and assessing blast events may include a sensing device configured for securing to a user or clothing article of the user. The sensing device may include a kinematics sensor configured for sensing accelerations associated with an event and for generating kinematic signal data based on the event. The sensing device may also include a computer-readable storage medium having instructions stored thereon for receiving the kinematic signal data from the kinematic sensor and storing the kinematic signal data and a processor for processing the instructions to capture the kinematic signal data. The system may also include a computing device configured for analyzing the kinematic signal data to classify the event as a blast event or not a blast event.

In one or more embodiments, a method of assessing a blast event may include sensing and recording a signal in response to a blast event and, using a kinematic sensor, generating a kinematic data signal. The method may also include classifying the event as a blast event or not a blast event based on the kinematic data signal.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a schematic view of a blast event being sensed with a kinematic sensor, according to one or more embodiments.

FIG. 2 is a diagram of a Friedlander Waveform.

FIG. 3 is a diagram of a kinematic sensing device in communication with an outside computing device via one or more communication systems, according to one or more embodiments.

FIG. 4 is a method diagram depicting a method of monitoring blast events using a kinematic sensor, according to one or more embodiments.

FIG. 5A is a raw diagram of linear accelerations sensed by a kinematic sensor during a blast event, according to one or more embodiments.

FIG. 5B is a raw diagram of angular accelerations sensed by a kinematic sensor during a blast event, according to one or more embodiments.

FIG. 6A is a filtered diagram of linear accelerations sensed by a kinematic sensor during a blast event, according to one or more embodiments.

FIG. 6B is a filtered diagram of angular accelerations sensed by a kinematic sensor during a blast event, according to one or more embodiments.

FIG. 7A is a raw diagram of linear accelerations sensed by a kinematic sensor during a head impact, according to one or more embodiments.

FIG. 7B is a raw diagram of angular accelerations sensed by a kinematic sensor during a head impact, according to one or more embodiments.

FIG. 8A is a filtered and truncated diagram of linear accelerations sensed by a kinematic sensor during a blast event, according to one or more embodiments.

FIG. 8B is a filtered and truncated diagram of angular accelerations sensed by a kinematic sensor during a blast event, according to one or more embodiments.

FIG. 9 is a bar graph depicting voltage-based scores of blast events, according to one or more embodiments.

FIG. 10 is a plan view diagram of a shooting ranging showing signals generated by sensing devices during a blast, according to one or more embodiments.

FIG. 11 is a plan view diagram of the shooting range of FIG. 10, showing scores of a blast for each of 5 users, according to one or more embodiments.

FIG. 12 is a table showing relationships between scores showing experienced magnitudes of a blast in conjunction with orientation and distance from the blast, according to one or more embodiments.

FIG. 13 is a diagram of a generally accepted probe type overpressure monitor.

FIG. 14 is a graph of pressures indirectly sensed by a sensor according to one or more examples of the present disclosure fitted to a curve, according to one or more examples.

FIG. 15 is a graph of sound measures indirectly sensed by a sensor according to one more examples of the present disclosure fitted to a curve, according to one or more examples.

FIG. 16 is a chart of overpressure counts per hour based on a user's role/position on a shooting range, according to one or more examples.

FIG. 17 is a report identifying top 5 blast work loads, total blasts, and blast daily load, according to one or more examples.

### DETAILED DESCRIPTION

The present application, in one or more embodiments, includes a system for relying on kinematic sensor data monitoring and assessing blast events. In one or more embodiments, the sensor may include accelerometers and/or gyroscopes that are designed and calibrated for sensing kinematic motion of the human body. That is, for example, the magnitudes of accelerations and associated sensitivity of the sensor may make it suitable for sensing kinematic motion of the human body. This sensor may be in stark contrast to commonly relied on pressure and/or acoustic sensing devices such as microphones or other sensors that are well suited for sensing sound or pressure. Moreover, the sample rates of the sensor may include frequencies suitable for kinematic motion as well. However, the sensor may nonetheless be equipped with, or the sensed data may be analyzed with, systems adapted to identify and analyze blast events. This starkly different sensor may be well suited to naturally filter out noise that may otherwise be picked up by common blast sensing equipment. The sensor may be well suited during a blast event for identifying the event to allow for counting several events. The sensor may also be well suited for estimating the magnitude of one or more sensed events. This may be particularly true where the sensor has been calibrated for the environment and the blast/acoustic wave(s) of interest. For example, for a 50-caliber rifle, the kinematic sensor output may be compared and calibrated to measurements taken from a high quality pressure/acoustic sensor used as a reference (e.g., a lab test). As such, the sensor system of the present application may be suitable for providing blast event information that can be used to monitor and assess exposed military personnel or for other purposes.

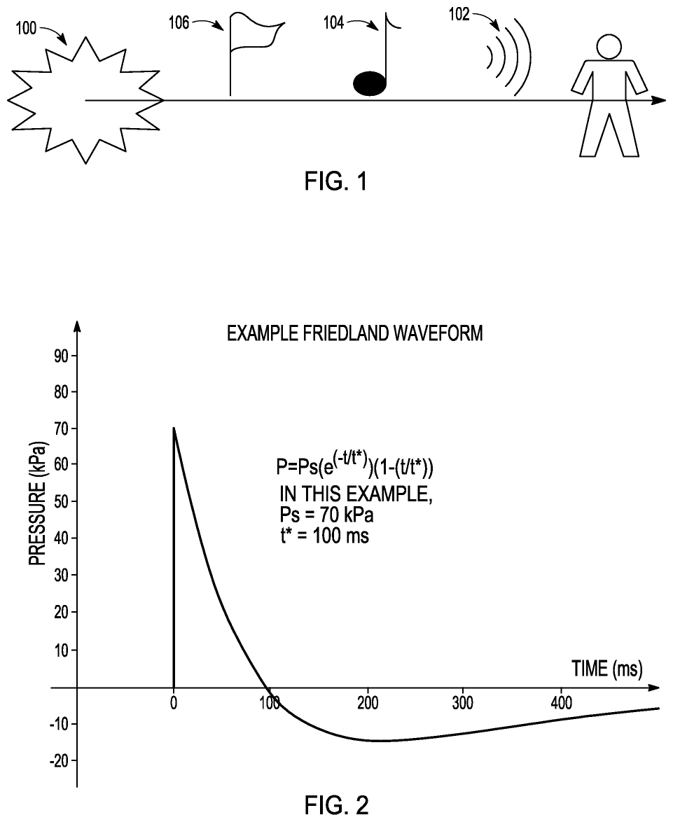

Turning now to FIG. 1, a schematic diagram of a blast event 100 is shown. In the diagram, a blast event has occurred and it has emitted three stages of waves. A first blast or shock wave 102 is emitted in the form of a wave of pressure propagating through the air or other medium in which the blast occurred. The blast may create an initial change in pressure over an extremely small amount of time (e.g., on the order of microseconds, μs; 0.000001 seconds) and the shock wave may travel at supersonic speeds. A second wave is a sound wave 104, which travels at slower sonic speeds, which means that the sound of the blast will be heard after the shock wave has already passed. Finally, a wind wave 106 is shown trailing the sound wave and propagating at subsonic speeds. The wind wave will, thus, be felt after the blast is heard. Of concern in the present application is the blast or shock wave 102.

As mentioned, the blast or shockwave 102 may result from a change in pressure occurring over an extremely small amount of time on the order of microseconds, μs. The shock wave 102 may have a variety of different amplitudes depending on the source of the blast. For example, hand grenades, mortar fire, flash-bang grenades, breaching charges, 50-caliber rifles, hand guns, recoilless rifles, and shotguns may emit blast waves having amplitudes on the order of 1-10 psi (e.g., 10-50 kPA). As shown in FIG. 2, the source of the blast may result in a pressure change occurring so quickly that it is depicted as a vertical line on a graph showing the wave form in milliseconds. After the blast, the wave may quickly drop off and create negative pressures within 100 milliseconds and approach zero by 500-600 milliseconds. To capture data sufficient to model this type of wave, a sensor having a sample rate of approximately 10-1000 kHz may commonly be used, with a prioritization of the initial near-instantaneous rise in pressure to the peak overpressure. That is, when the entire event or wave is complete with 600 milliseconds, sensors capable of sensing the pressure at least every microsecond (e.g., 100 kHz) are used to model the pressures. In view of this, a paradigm of using pressure sensors having pressure sensitivities and sample rates on the order of 10, to 100, to 1000 kHz are common. The present application identifies a different approach.

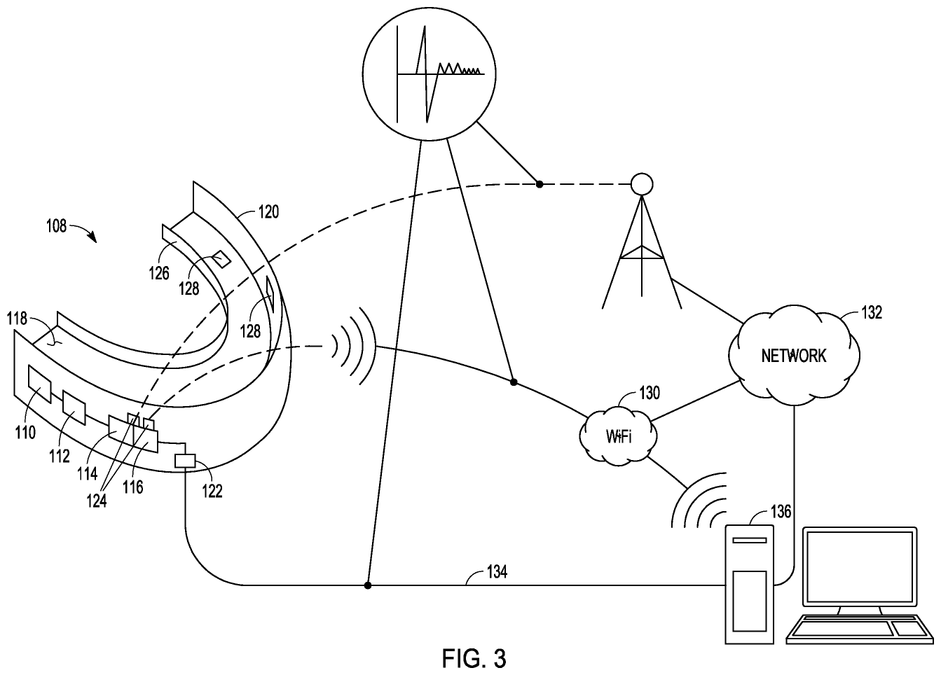

Turning now to FIG. 3, one embodiment of the kinematic sensing device 108 of FIG. 1 is shown. As shown, the sensing device may be in the form of a mouthguard configured for kinematic sensing such as a mouthguard worn by athletes during athletic events and having sensing equipment thereon for sensing head impacts. In one or more embodiments, the sensing device 108 may include a body portion and an electronic system including a power source 110, one or more sensors 112, a data storage medium 114, a processor 116, input/output devices 122, and/or receiving and transmitting systems 124.

The body portion may be in the form of a mouthguard or an alternative wearable device may be used. The alternative wearable device may be, for example, a body or skin patch, a clothing patch, a head band, mouthpiece, earpiece, or other wearable. That is, while a mouthguard may provide tight coupling to the user that is useful for sports impacts, the present use of the sensors does not appear to rely on tight coupling to sense the blast waves. As such, wearable or non-wearable devices may be used. For example, the device may be placed on a uniform (by Velcro attachment, inside a pocket, secured by a strap/tether) or on/inside a helmet or on footwear (attached to a boot) or even on a weapon (attached to the stock, for example). In the case of a mouthguard, the mouthguard may include a dentition portion 118, a labial portion 120, and a lingual portion 126. The dentition portion 118 may be generally flat and u-shaped and adapted for resting on and/or being positioned between the crown of the teeth. In one or more embodiments, the dentition portion 118 may be adapted for molding to the teeth using a heating and biting process or the dentition portion may be custom fitted and molded, for example. The dentition portion may include an inner u-shaped edge and an outer u-shaped edge. The labial portion 120 may extend upwardly and/or downwardly from the outer u-shaped edge of the dentition portion and may be configured to protect the labial surface of the upper or lower teeth. The lingual portion 126 may be provided extending upward and/or downward from the inner u-shaped edge of the dentition portion and may be configured to keep the tongue from slipping between the teeth, for example.

The electronic system may be arranged on the surface of, lodged within, molded within, or otherwise associated with the body portion. In one or more embodiments, the electronics system may be over-molded within the labial or lingual portion of the mouthguard. In one or more embodiments, the mouthguard may be manufactured consistent with the system and methods described in U.S. patent application Ser. No. 16/682,656, filed on Nov. 13, 2019, and entitled Impact Sensing Mouthguard, the content of which is hereby incorporated by reference herein in its entirety. Still other approaches to manufacturing the mouthguard may be used.

The power source 110 may be an electric power source configured for providing power to the sensors, the storage medium, and the processor. In one or more embodiments, the power source may be in the form of a battery such as a nickel cadmium alloy battery, a metal hydride battery, microscopic batteries, or another battery suitable for powering micro electro-mechanical devices.

The sensors 112 may include sensors adapted for sensing kinematic body motion of an athlete, military personnel, or other human user such as those resulting from bodily impact or collision, for example. In one or more embodiments, the sensors may include accelerometers including linear accelerometers, angular accelerometers, gyroscopes, or other motion sensing micro electro-mechanical devices. In one particular embodiment, a 3-axis linear accelerometer may be provided together with a 3-axis gyroscope. The linear accelerometer may be configured for sensing linear accelerations along x, y, and z axes and the gyroscope may be configured for sensing angular accelerations along the same set of x, y, and z axes. In one or more embodiments, manufacturing techniques may be used to align the local axes of the two separate sensors. In other embodiments, mathematical techniques may be used to determine any out of alignment issues and to normalize the two sets of data to reflect the same set of axes. In one or more embodiments, the normalization may be performed to correspond with a human anatomy axis, where X may be directed anteriorly, Y may be directed laterally, and Z may be directed upward. In another embodiment, sensors that have directional sensitivity may be oriented such that a more or less sensitive axis may be positioned orthogonal and/or parallel to the blast/acoustic wave.

As mentioned, the sensor 112 may be kinematic or motion sensors. That is, the sensors 112 may be adapted for sensing kinematic motion of the human body. As such, the sensors may be designed, sized, and calibrated for sensing a range of accelerations commonly reflected by the motion of an athlete during athletic events and, in particular, during an impact event. For example, the sensors may be calibrated for sensing accelerations having magnitudes ranging from approximately 0 g's to approximately 300 g's, or from approximately 0 g's to approximately 250 g's, or from approximately 0 g's to 200 g's. Still other magnitude sensors may be used. For example, low-g, medium-g, and/or high-g sensors may be used such as a low-g (e.g., 0-4 g or 0-16 g), or a medium-g (e.g., 0-50 g or 0-100 g), or a high-g (say 0-200 g or 0-250 g or 0-300 g). Moreover, the sensors may have sample frequencies adapted for modeling motions of the human body in response to impacts. Impacts to the human body such as those experienced by football players or other athletes may occur over a period of time of approximately 10 milliseconds; about 1000 times slower than blast or shock waves. As such, the sampling rates of kinematic sensors 112 may be much less than the sampling rates of sensors adapted to sense blast or shock waves. In one or more embodiments, the accelerometers, gyroscopes, and other MEMS sensing devices of the present disclosure may have sample rates ranging from approximately 10 Hz to approximately 10,000 Hz, or from approximately 500 Hz to approximately 7500 Hz, or from approximately 1000 Hz to approximately 5000 Hz, or from approximately 1500 Hz to approximately 4500 Hz, or from approximately 2500 Hz to approximately 4000 Hz, or from approximately 3000 Hz to approximately 3500 Hz, or a sample rate of approximately 3200 Hz may be used. In one or more embodiments, an accelerometer such as an ADXL 372 manufactured by Analog Devices may be provided. This particular accelerometer may have a range of 200 g's and a bandwidth or sample rate of 3200 Hz.

The sensors used in the present application, whether referred to as kinematic sensors or motion sensors, are built to measure motion of the thing they are attached to. For example, when used in the context of sports, motions may be transmitted from an object (e.g., the head) through a rigid mounting (e.g., mouthguard coupled to the teeth) into the sensor resulting in measured accelerations that may be converted into a g-force. Uniquely, in a blast event experienced by a user, no blast-related motion is occurring before the blast wave passes through. Due to this lack of motion, it may not be intuitive to use a motion sensor to sense and/or assess a blast wave. Moreover, the sensors of the present application may be hermetically sealed such that air pressures around the sensor do not reach the accelerometers or gyroscopes within the sensor. Since a blast wave is a pressure-based wave, one of skill may not look to motion or kinematic sensors for sensing blast waves.

Apart from the kinematic sensors, the one or more sensors may include control sensors 128 adapted for use to filter data and/or control the kinematic sensors 112 to avoid collecting data, for example. In one or more embodiments, the control sensors 128 may be proximity sensors, capacitive sensors or other sensors allowing for assessments to be made about whether the mouthguard is actually in the mouth and/or on the teeth of the user. Where a non-mouthguard type sensor is used, the control sensors 128 may be used to determine or assess other mounting arrangements such as whether the sensing system is properly affixed to the uniform and/or boot(s) and/or helmet, etc. This information can be used to awaken and/or trigger the electronics of the system, to filter out data if the system is sensing information when the device is not on the teeth or otherwise mounted for sensing blast waves and/or for other purposes. In one or more embodiments, multiple control sensors 128 may be provided to more accurately determine when the mouthguard or other sensing device is in position for sensing. For example, two control sensors may be positioned on a mouthguard in positions that are not normally both covered unless the mouthguard is in position in the mouth and on the teeth. For example, control sensors facing inward from the labial portion in two different locations around the periphery of the mouthguard may be provided. As such, unless an object is within the channel formed by the labial and lingual flange 120/126 and the dentition portion 112, and is within that channel at both sensor locations, the system may be in a sleep or off state or data collected during that timeframe may be ignored. That is, when the mouthguard is on the teeth, both sensors may be covered and an object may be sensed within the channel at both locations, so sensing with the kinematic sensors may be appropriate. However, when the mouthguard is in a case or in a gym or military bag, the sensing may not be appropriate, and it may also be unlikely that both sensors would be closely covered in those situations. While a description has of a mouthguard approach has been provided for determining when a mouthguard is in position for sensing, other approaches may be used for other sensor mounting types. For example, in the case of a boot-mounted sensor, the control sensor may be positioned and configured to assess when a user is wearing the boots, for example. In the case of a helmet, the control sensor may be positioned and configured to assess when a user is wearing a helmet. Still other approaches to using control sensors to assess when the system is in position for sensing to assist in collecting meaningful data may be provided.

The data storage medium 114 of the electronic system may be a computer readable data storage medium such as volatile memory (e.g., random access memory (RAM)) and/or non-volatile memory (e.g., read-only memory (ROM, EPROM, EEPROM, etc.)). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data. In addition to facilitating communication and data and signals, the memory may include computer readable instructions particularly adapted for communicating with separate computing systems (e.g., for performing receiving and transmitting operations), controlling on/off states of the sensors, for monitoring the condition of the mouthguard (e.g., on the teeth, off the teeth, etc.), for receiving sensor data, for controlling on/off and/or sleep states of the processors, etc. In one or more embodiments, the memory may include computer readable instructions adapted to receive, store, and and/or analyze sensor data such as accelerometer signals received from a head impact and/or a blast event. These computer-readable instructions are discussed in more detail below.

The computer processor 116 of the electronic system may be adapted to execute the computer-readable instructions on the data storage medium. For example, the various sets of instructions on the computer readable storage medium for facilitating communication between components within the system, the more specific controls of the sensors and the receipt of data from the sensors may all be processed and/or executed by the processor. In one or more embodiments, the processor may be a high performance unit such as a 32-bit microcontroller from ST Microelectronics, for example.

Input/output devices 122 may also be present on the sensing device for powering up, for example, resetting, or otherwise directly interacting with the sensing device. Moreover, while the sensing device has been said to have computer-readable instructions and a processor for analyzing the sensor data or sensor signals, this analysis may be performed by a separate computing system as well. As such, the sensing device may be equipped with receiving and transmitting devices 124 operable by the processor and the storage medium to receive instructions from outside computing devices and/or to transmit information including the sensor data to outside computing devices. The receiving and transmitting devices may include local area network (LAN) type devices and may include WiFi, Bluetooth, Zigbee, or other relatively local area communication systems. Alternatively or additionally, the receiving and transmitting devices may include wide area network (WAN) communication capabilities such as cellular or other communication systems. As shown in FIG. 3, sensor data may be transmitted via a local area network 130, a wide area network 132 such as the internet, or via a direct hardwire communication 134 to an outside computing device 136 for monitoring and/or analysis. In one or more embodiments, a combination of these communication systems may be used.

The sensing device 108 may be the same or similar to those that are shown and described in U.S. Pat. Nos. 9,044,198, 9,149,227, 9,289,176, and 9,585,619, the contents of which are incorporated by reference herein in their entireties. Still other sensing devices and process may be used, such as those described in U.S. Pat. Nos. 8,537,017, 8,466,794, 9,526,289, 8,554,495, and 9,554,607, the contents of which are incorporated by reference herein in their entireties. Still other sensing systems and processes may be used, such as those described in U.S. patent application Ser. Nos. 13/009,580, 14/040,157, and 14/040,111, the contents of which are incorporated by reference herein in their entireties.

In operation and use, the sensing device may be used to monitor and/or analyze blast events. That is, while the sensing device may include kinematic sensors not commonly thought to be suitable for detecting, monitoring, or analyzing blast events, the methods herein described reveal a very useful application of a kinematic sensor system to this arena.

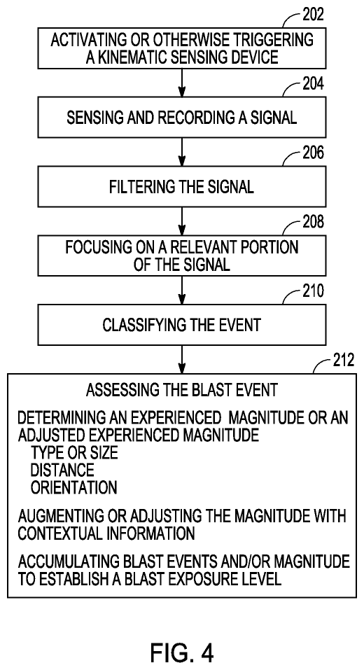

In one more embodiments, and with reference to FIG. 4, a method (200) of monitoring and analyzing a blast event using kinematic sensors may be provided. The method may include activating or otherwise triggering a kinematic sensing device (202) to cause the device to be awake and/or otherwise ready for sensing an impact, a blast event, or other event. The method may also include sensing and recording a signal (204) in response to the event. The method may also include filtering the signal (206) and focusing on a relevant portion of the signal (208). The method may also include classifying the event as a blast or non-blast event (210). Still further, additional processing may be provided to assess one or more blast events (212).

Activating or otherwise triggering a kinematic sensing device (202) may be performed in one or more ways. In one or more embodiments, a control sensor may be provided for helping to determine when information sensed by the kinematic sensors is relevant information. (i.e., when the sensing device is in position for sensing) For example, as mentioned, the control sensors may be configured to determine when the sensing device is placed within a user's mouth or on a user's teeth. In one or more embodiments, the control sensor may determine when respective obstructions are present or within close proximity to each of two sensors. Where each of the two proximity sensors sense an obstruction, the system may be configured to trigger the sensing system on or awaken the sensing system such that the sensors in the system are on alert for potential impact and/or blast events. In other embodiments, as outlined above, other approaches to determining when a sensor is in position for sensing may be provided. In addition to assessing whether the sensing device is in position for sensing, activating or triggering a kinematic or motion sensing device may involve use of an active/sleep/wake mode. That is, for purposes of conserving battery power, the sensing device may remain asleep or in ultra-low-power mode, for example and then rapidly wake up into active mode to sense a blast wave. The waking up of the sensor may occur based on a sensed signal of interest, for example. In other embodiments, other systems or methods may be provided for triggering and/or awakening the sensing device.

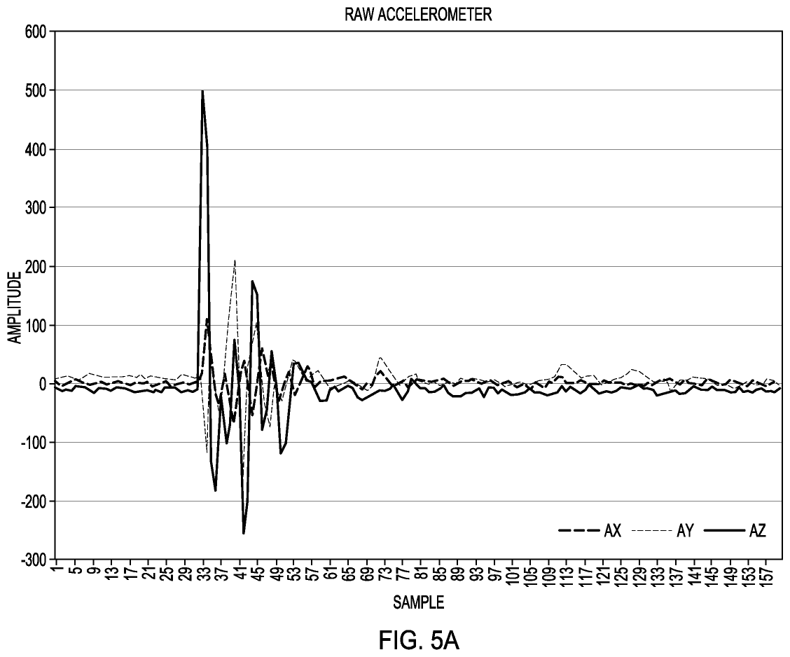

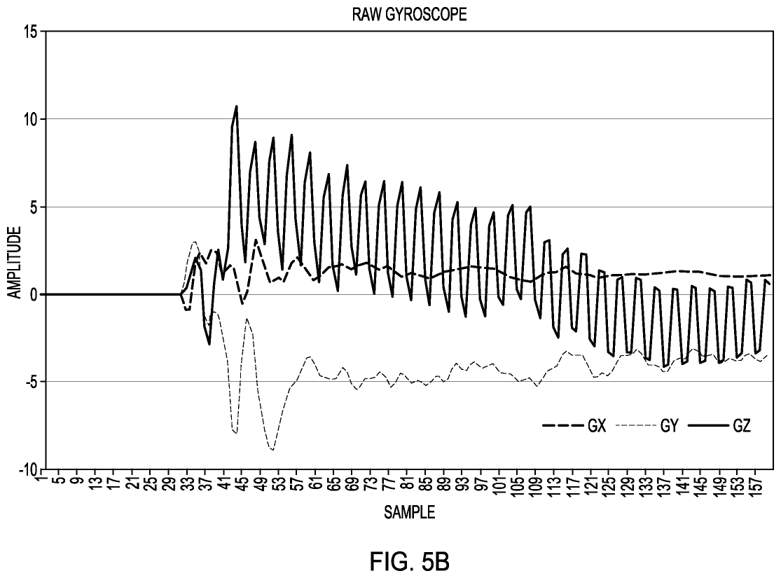

In an alert or triggered state, the sensing device may be ready for sensing an impact event, blast event, or other event. The method may include sensing and recording a signal. (204) In one or more embodiments, as shown in FIGS. 5A and 5B, sensing and recording a signal may include sensing and recording signals across a range of variables including multiple linear accelerations and multiple angular accelerations. For example, sensing and recording a signal may include sensing linear accelerations along local x, y, and z axes of the sensing device. Still further, sensing and recording a signal may include sensing angular accelerations about these local axes as well. The sensing may be performed with a sample rate consistent with kinematic sensing as discussed above. In FIG. 5A, a blast event is shown where a sample rate of 1 to 4 kHz was used with a series of kinematic sensing accelerometers and gyroscopes. As shown, the blast event may result in excitation of the linear accelerometers over a period ranging from approximately 30 samples to approximately 60 samples and ranging from approximately −200 millivolts to approximately 500 millivolts. Similarly, FIG. 5B shows excitation of the x axis and y axis angular accelerometers over a period ranging from approximately 30 samples to approximately 60 samples. The z-axis angular accelerometer shows excitation in a more ongoing fashion staring at approximately 30 samples. These signals may be stored in the memory of the sensing device and/or transmitted to a different computing device as shown in FIG. 3. It is to be appreciated that the relative ratio of the high frequency portions of the signal compared to the lower frequency portions of the signal (e.g., how spiky the data is and the distance in time between the peaks) may be indicative of a blast event and may also be indicative of particular magnitudes. That is, the actual g-force reflected by the accelerometers and the actual revolutions/minute reported by the gyroscope (e.g., magnitude) may not be as relevant as the rapidly oscillating signals (e.g., frequency).

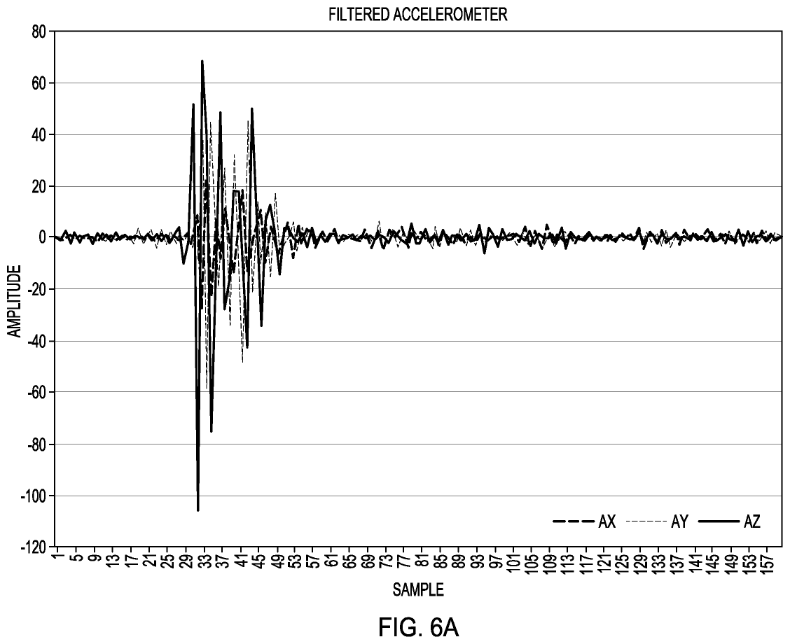

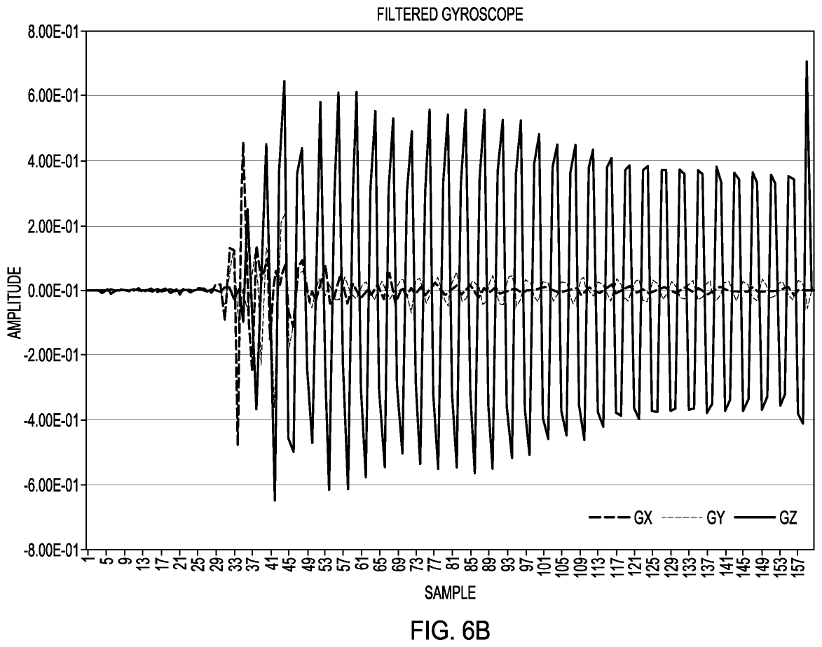

Turning now to FIGS. 6A and 6B, filtering the signal (206) may include filtering the signal with a high-pass filter, for example, that removes all frequencies below 1000 Hz. This step may also include zeroing out the signal such that the signal starts at 0, not some other value. That is, as shown in FIGS. 6A and 6B, applying the filter may clean up the linear acceleration signals in that the oscillations about 0 may be more uniform, for example. In particular, with respect to FIG. 6B, the angular velocities may be much more centered about 0. The filtering may, for example, remove physical motion of the sensing device, which occurs over a much longer period of time and, as such, at a much lower frequency and instead, focus on the “rattle” resulting from the blast event. Other accelerations and velocities associated with physical vibrations due to mechanical movement and not due to blast/acoustic waves, for example, may also be removed by filtering the signal. As shown in FIG. 6A, the blast event may result in a filtered signal that shows excitation of the linear accelerometers over a period ranging from approximately 30 samples to approximately 60 samples and ranging from approximately −100 millivolts to approximately 50 to 70 millivolts. FIG. 6B, again, shows excitation of the x axis and y axis angular accelerometers over a period ranging from approximately 30 samples to 60 samples while the z axis shows excitation in a more ongoing fashion starting at approximately 30 samples. It is to be appreciated that using a high-pass filter on a signal generated by a kinematic or motion sensor may be significantly contrary to conventional wisdom. That is, since kinematic or motion sensors are used for sensing motion, low-pass filters may commonly be used to filter out noise or other high frequency signals to reveal the motion of interest. Said another, way, using a high-pass filter on a signal generated by a motion or kinematic sensor would commonly be thought to get rid of the meaningful data and, instead, show the meaningless data. In particular, since motion or kinematic sensors are not designed to sense high-frequency signals, those of skill in the art would tend to suggest that the data that is outside the frequencies of interest is not only not meaningful, but actually meaningless.

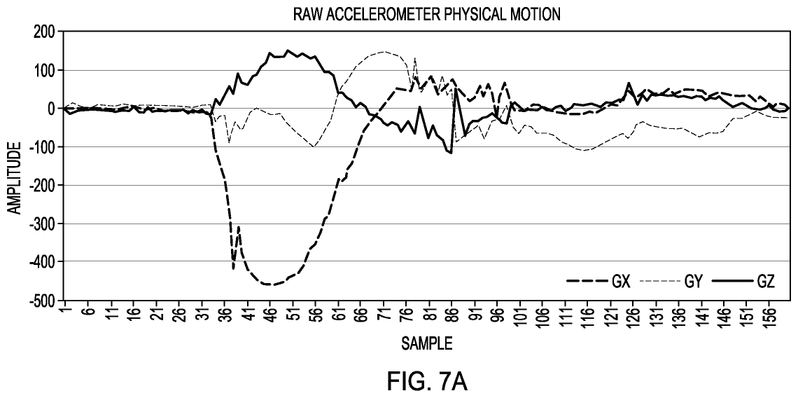

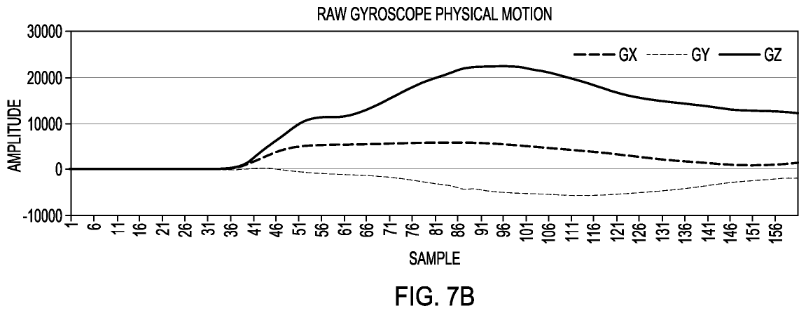

By way of comparison, FIGS. 7A and 7B show signal results from a physical impact using the same sensing device. As shown, the physical impact signal may have a much longer period and, thus, lower frequency as compared to the blast signal shown in FIGS. 5A-6B. By removing the lower frequency aspects of the acceleration signal, the higher frequency signal relating to the blast event may emerge.

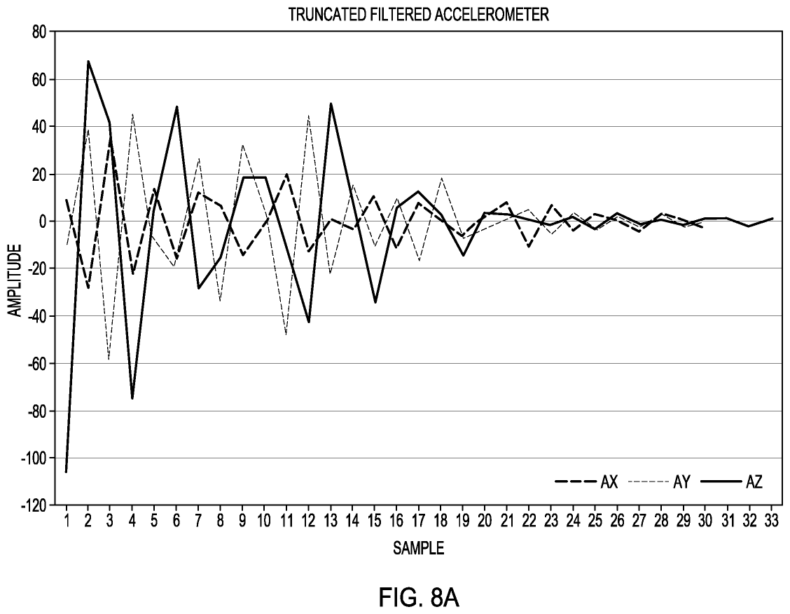

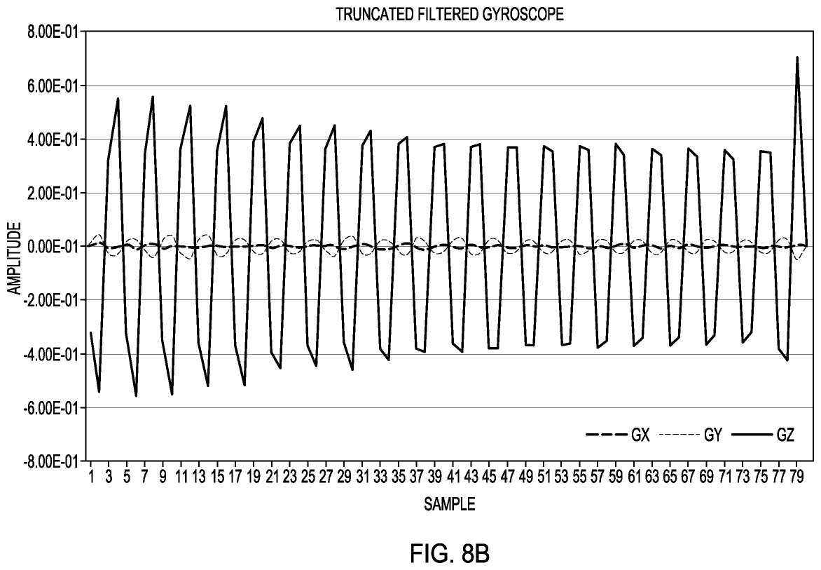

Having isolated the blast aspects of the signal from the raw acceleration data, further refinement of the signal may be made. For example, the system may focus on the relevant portion of the signal by truncating the signal (208). As shown in FIGS. 8A and 8B, the signal may be truncated depending on the nature of the signal. As shown, the relevant aspects of the linear acceleration signals may range from approximately 30 samples to approximately 65 samples on FIG. 6A and a truncated version of that data is shown in FIG. 8A where the time between 0 and 30 samples is removed and the time after 65 samples is removed such that the signal is shown over a window of approximately 35 samples. Similarly, the relevant aspects of the angular velocity signals may range from approximately 30 samples to approximately 110 samples on FIG. 6B and a truncated version of that data is shown in FIG. 8B where the time between 30 and 110 samples is shown over a window of approximately 80 milliseconds. It is to be appreciated that ongoing signals from sensors may allow for multiple blast events to exist on a given signal and the above approach may allow for focusing on one or more of the signals, isolating the signals from downtime or other non-relevant data, and or parsing several blast events into separate events.

With the signals from the event such as those shown in FIGS. 8A and 8B, or even those shown in FIGS. 6A and 6B, the event may be classified (210). That is, based on the frequencies present along the several linear and angular axes, the event may be classified as a blast event or not a blast event. The ability to classify this event as blast or not blast may provide for the ability to count a number of blasts and develop an overall exposure for military personnel. In one or more embodiments, the signals may be indicative of a blast event if the data collected appear like FIG. 6A and/or FIG. 6B, or if a region of interest in the data collected appears as in FIG. 8A and/or 8B. In general, a non-blast event collected by a motion sensor will have frequency content below 500 Hz, whereas the blast/acoustic signatures collected from kinematic sensors will occur above 500 Hz to 1000 Hz frequencies. To be clear, since the accelerometer readings are indirect blast/acoustic measures based on sensations occurring around the blast event and not at the blast event and because the blast wave is not being sensed directly (i.e., using a pressure sensing device), the classification of the event as a blast event or not a blast event may be based on empirical studies and calibration using the accelerometers. For example, testing may be conducted with the sensing device in the presence of known blast events and the several factors mentioned for classifying the event as a blast event or not a blast event may be assessed in conjunction with known blast events. Where these factors appear on the accelerometer signals for other blast events, these factors can be used to classify the event.

More particularly, a computing system may be used to monitor the signals received from the sensors. The computing system may review the signal for high frequency content in the signal and check to see if the high frequency is reverberating for long than a few milliseconds. For example, in FIG. 5B, the z-axis is particularly excited by the blast wave. As shown, a high frequency is riding on top of the lower frequency head motion and that high frequency carrier signal reverberates for the entire data record. In this way, a computing system may be programmed with computer readable instructions suitable for identifying a blast event appearing within a signal from a motion or kinematic sensor.

In addition to classifying the event as a blast event or not a blast event, which may allow for counting a number of blast events, further processing may be performed to assess one or more of the blast events (212). That is, any given blast event may have an effect on individuals around the blast event. Moreover, the effect may be dependent on one or more factors such as type or size of blast, distance from the blast, and orientation to the blast. Depending on the amount of context provided in association with the sensor signals, the assessment may take one or more forms.

In one or more embodiments, where little to no context is provided in association with the signal data, the assessment may include determining an experienced magnitude and/or an adjusted experienced magnitude. As mentioned, the magnitude of any particular type or size of blast experienced by the user may be affected by a user's distance from the blast and their orientation to the blast. Where no context is provided with the signal, the actual distance from the blast may not be known. However, the fact that the sensor is at the location of the user may cause the sensor to react different from a sensor positioned at the blast location. As such, and even though the motion sensor is not directly measuring blast pressure, the signal generated by the motion sensor may, nonetheless, be affected by its distance from the blast event. Accordingly, the signals produced by the motion sensor may be used to calculate and/or estimate the magnitude experienced by the user.

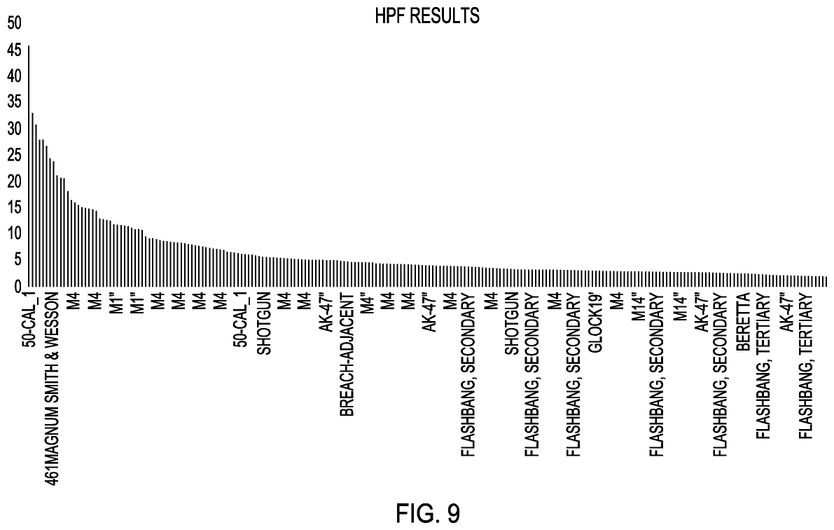

In one or more embodiments, a generic, unitless, and/or proprietary scoring system may be created based on the relative reactions of the motion sensor in various conditions. In one or more embodiments, the scoring system may be based on a filtered and/or modified sensor voltage value. That is, for example, with a filtered signal as discussed with respect to FIGS. 6A/6B, the peak magnitude may be selected from the signal. In one or more embodiments, the signal values may be squared to make all of the negative values positive and to magnify the values. The magnification may further separate the peaks and increase their prominence with respect to other values that may be close to the peaks. The squaring may also make all of the values positive, which may allow for selecting the maximum peak with consideration given to both the positive and negative voltages at one time. The highest of these values may be extracted as an indicator of the size of the blast experienced by the user. The scoring system may, thus, create a sort of scale against which future blast experiences may be charted. As shown in FIG. 9, such voltage-based scores may allow for some level of comparison between a series of experienced magnitudes by users.

In still other embodiments, a series of tests may be run with one or more motion sensors and a scoring system based on overpressure may be developed. That is, for example, a series of blast tests may be performed using a motion sensor and a pressure sensor such that the reactions of the motion sensor may be correlated to particular overpressures, impulse, and/or pressure versus time data sensed by the pressure sensor. These empirical studies may allow the motion sensor to be calibrated or correlated to particular overpressures and, as such, the scoring system in this situation may actually be an estimate of the overpressure experienced in kilopascals (kPa) or pounds per square inch (psi), impulse experienced in kPa-sec or psi-sec, and pressure at any point being defined as a function of time. In one or more embodiments, for example, the voltage-based scores discussed above may be correlated with a particular overpressure allowing the overpressure experienced by the user to be calculated and/or estimated to provide the experienced magnitude in terms of pressure. A bar graph similar to that of FIG. 9 may, thus, be generated with units of pressure.

Regarding orientation, in one or more embodiments, multiple sensors may be used (e.g., front, side, back). A comparison of the sensor results for the several sensors may allow for an ability to assess which direction the blast came from. However, even without multiple sensors, orientation of the user as compared to the blast event may be determined or estimated. That is, preliminary testing may be performed where multiple sensors are positioned at multiple points around a blast location. For example, at any given test location, multiple sensors may be provided and several test locations around the blast location may be equipped with sensors. The testing may allow for directional fingerprints to be identified based on how the sensors react to the same blast experienced for different directions. In one or more embodiments, the fingerprints may be based on the relative reaction of the accelerometers or the gyroscope along one or more axes within each sensor. In some embodiments, overlapping test results may occur. For example, a sensor positioned 15 feet from the blast in a Southeast (or back right) position and a sensor positioned 15 feet from the blast in a Northwest (or front left) direction (e.g., diagonal quadrants) may have same or similar fingerprints. Nonetheless, some level of orientation information may be gleaned from the signals themselves and included in the results.

Given the orientation information, an adjusted experienced magnitude may be provided. That is, for example, factors may be assigned to blast waves depending on the orientation of the user to the blast wave. In one or more embodiments, blast waves experienced from the front may be considered and/or shown to be more detrimental than blast waves experienced from the back. Blast waves experienced from the side may be considered to establish a middle ground to blast waves experienced from the front or back, for example. In one or more embodiments, helmets or other protective gear may, for example, shield, filter, or otherwise dampen the internal effect of a blast wave on a user's brain or other internal organs. In any case, for example, the factors may be used to increase or decrease the experienced magnitude to establish an adjusted experienced magnitude. For example, where a blast wave is identified on a signal and the orientation information indicates that the wave was likely or did come from the side of the user, a factor of 1, or no adjustment, for example, may be made to the experienced magnitude. However, where the orientation information indicates that the blast wave came from the back, a factor of less than 1 may be used to reduce the effect of the blast, thus, establishing a lower adjusted experienced magnitude. Still further, where the orientation information indicates that the blast came from the front, a factor greater than 1 may be used to amplify the sensed blast level to a higher value for purposes of recording the adjusted experienced magnitude.

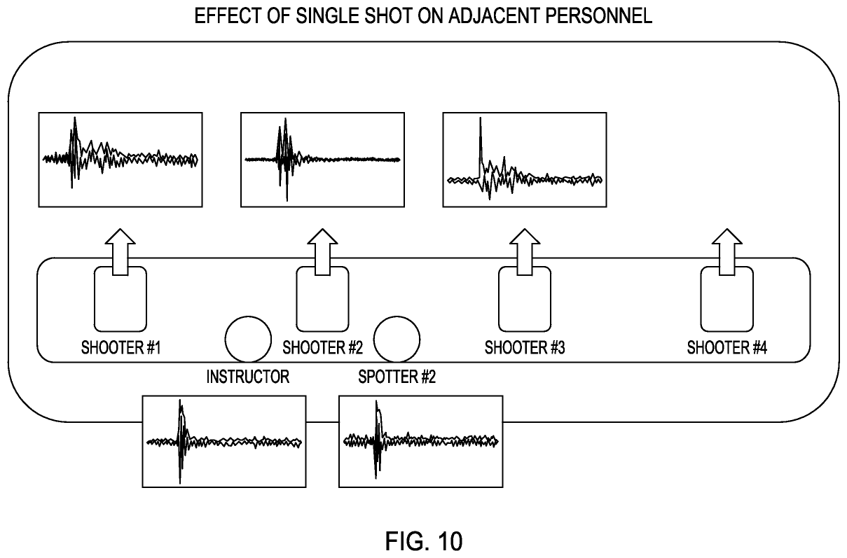

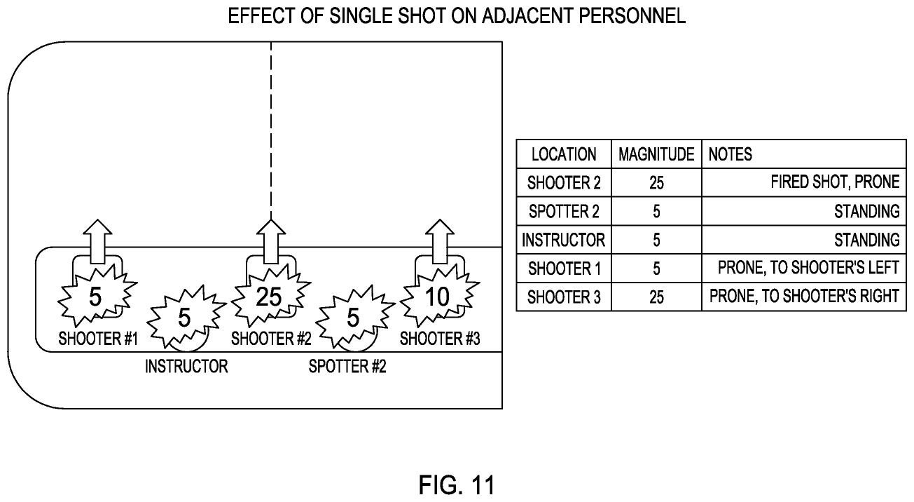

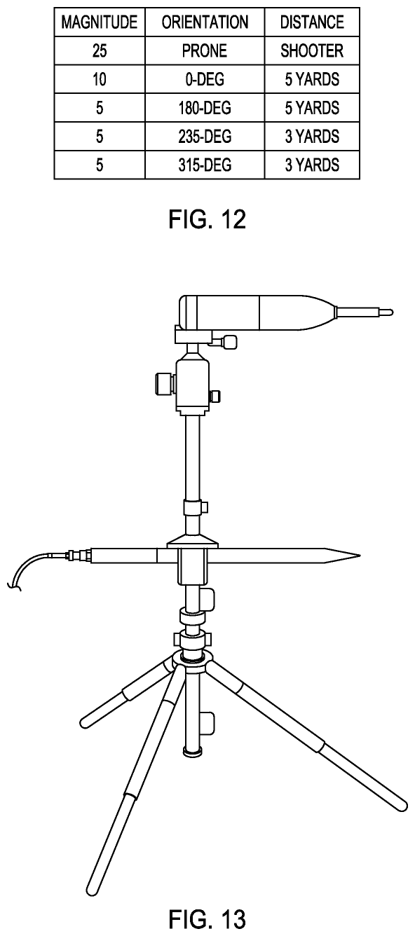

As may be appreciated, much can be done with the motion sensor signals even if the signals are provided with little to no context of the environment the sensors were used in. However, where contextual information about the environment is provided, still further value may be gleaned from the sensor information. For example, and as shown in FIG. 10, sensor information may be provided with knowledge that the sensor information was generated at a shooting range, a particular shooting range, a military shooting range, or a particular military shooting range. This information alone may provide for multiple additional opportunities for data assessment. For example, the timestamps may be used to align particular blast events experienced by one user with blast events experienced by one or more additional users. This may allow for affirmation of the count for each user simply by confirming that more than one person experienced a blast event at the same time. In some cases, the additional data assessment may be based on data that is known about the particular shooting range. That is, the signals from multiple users may allow for a comparison and potential after-the-fact calibration or adjustment may be provided. That is, spatial and situational information about the shooting range may be known. For example, the distances between the various positions of the personnel at the shooting range may be known. Moreover, the body positions of the shooters as compared to the instructor and spotter may also be known. For example, at a military shooting range, the shooters may be in a prone or laying down position. The instructor and the spotter, on the other hand, may be standing. As shown in FIG. 11, the experienced magnitude by each of the users at the various positions may have a relatively defined relationship based on their respective distances and orientations to the blast event. As may be expected, and as shown in FIG. 11, the shooter that fires the shot (e.g., shooter 2) may have the highest experienced magnitude. Where the shooter is right-handed and, as such, is laying on the left side of the weapon, shooter 3 may be relatively exposed to the blast and may experience a reduced, but next highest magnitude. Shooter 1, on the other hand, may be shielded from the blast by shooter 2's body and, as such, may experience a lesser magnitude. Still further, and although closer than shooter 1 and 3, the instructor and the spotter may experience magnitudes akin to shooter 1 due to being behind the blast and/or being behind a barrier or other protective system. As may be appreciated, relative experiences of the personnel at the shooting range may be expected to remain relatively constant even though the blast event itself may change. For example, if a smaller weapon were used, the shooter may experience a blast of 10, shooter 3 may experience a blast of 4, and shooter 1, the instructor, and the spotter may experience a blast of 2. These values may be in the form of a unitless score, a voltage-based score, a correlated pressure-based score, or another scoring value. Moreover, data tables that begin to relate particular blast events based on type or source of blast, orientation, and distance from the blast may be developed as shown in FIG. 12.

In one or more embodiments, knowledge of these relative positions and body positions may allow for further assessment of the sensor signals. For example, the data may be augmented by adding weapon type information and/or a size of the source blast. The data may be further augmented by providing distance information from the blast and/or orientation information. In one or more embodiments, the mere fact that the blast was at a shooting range may allow for assumptions about orientation. For example, with knowledge that no one is allowed to go in front of or beyond the shooting line and assuming everyone is facing forward, orientation estimates that allow for back right or front left options may be pared down in favor of orientations that are consistent with the situation (e.g., no back right exposures because no one is in front of and facing away from the shooter). While multiple sensors was discussed above in situations where no context is provided, the shooting range example provides for a single sensor on multiple people or multiple sensors on multiple people, which may be used to confirm and/or assist with orientation and/or blast direction as well. In one or more embodiments, the contextual information may allow for a, sort of, reverse application of the orientation factors. For example, where the estimated orientation of the user with respect to the blast is determined to be incorrect, the adjusted experienced magnitude may be increased or decreased based on the knowledge of the situation and in an effort to apply a suitable factor for orientation.

In one or more embodiments, the series of blast events experienced by a user may be accumulated to establish an exposure level. In one or more embodiments, an exposure level may simply be a number of blast experiences or a total count. In other embodiments, an exposure level may be a number of blast experiences that is weighted by the experienced magnitude of each blast. In still other embodiments, an exposure level may be an accumulation of the experienced magnitudes. Still further, the exposure level may give some consideration to time and, as such, the exposure level may be an exposure level per unit time or an exposure level over a particular period of time. In one or more embodiments, particular time intervals may be used to discount or even eliminate the effect of one or more blast experiences. These accumulated values may be provided whether the assessment above is based on signals without context or on signals with context.

### Example

Blast force, intensity, frequency, and duration of dosing for military personnel is poorly defined. This knowledge gap has potentially detrimental consequences for military personnel who are repetitively exposed to blast during training. In particular, breachers, weapons training instructors, artillery/mortar/grenade trainers, and special warfare personnel are at relatively high risk.

This example summarizes data acquired from a blast force monitoring sensor according to the present application. The data compares the sensor response to generally accepted standard relying on overpressure and acoustic sensors. Two parameters in the present example included the magnitude and the number of events, which can be easily translated as the rate of exposure per hour for several military training environments.

The blast sensor used here is based on a TRL9 Impact Monitoring Mouthguard (IMM) system, modified to each environment. The blast exposure data was aggregated automatically into an existing iOS application, with pass through to a secure Azure-based web portal. Automated reports were generated for each sensor.

The monitoring system hardware was modified to take on several different form factors including on the teeth, in a pocket, on a uniform, and affixed to a structure. In all cases, the monitoring system was used in military training environments to determine whether it could be used to quantify two overpressure exposure parameters: 1) the number of exposures (count), and 2) overpressure magnitudes (peaks). For purposes of this determination, the sensor system was compared to generally accepted standard reference probes on a military rifle range as shown in FIG. 13. A total of 1,893 overpressure exposures were measured in the analysis, and the peak overpressure was in the range of 0.1 psi to 10 psi across breaching, close quarters tactics (CQT) and weapons training.

The modified hardware was found to have an omnidirectional response to overpressure and counted 100% of overpressures versus audio-recordings on the rifle range, breaching, and CQT shoot-house environments.

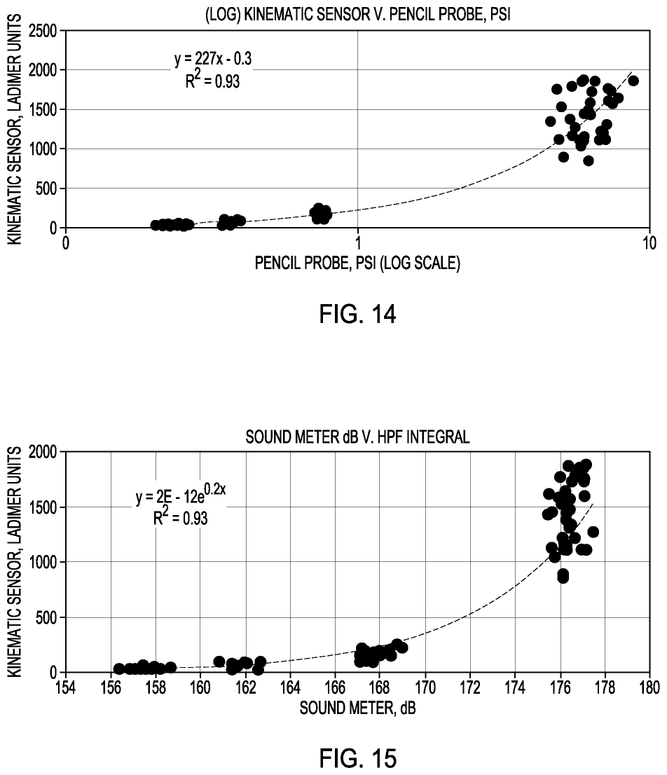

Compared to reference pencil pressure probe measures of n=102 0.50 cal unsuppressed shots fired over 14 minutes, the modified hardware fit a linear model of overpressure of the form y=227× with an R2 of 0.93 as shown in FIG. 14.

As measured on the rifle range at the reference probe location (˜1 m from firing position #1), the .50 caliber weapon produced 37 overpressure events during 14 minutes in the range of 4.6 to 8.8 psi reference. Based on acoustic recordings and measures from the modified hardware mounted at the reference location, there were a total of 144 rounds fired over 46 minutes from four (4) firing locations that generated reference overpressures ranging from 0.2 to 8.8 psi.

For breaching instructors who wore the modified hardware alongside audio recordings to verify timing of overpressure events, they sustained an estimated 1-2 overpressure events per hour greater than 4 psi, up to 100 overpressure events per hour between 1 to 4 psi and up to 168 overpressure events per hour less than 1 psi based on calibrated output from the modified sensor.

The blast monitoring technology has the capability to count blast exposures within 6 m of the source with 100% accuracy, and estimate overpressure within 1 psi, for blasts in the range of 0.1 psi to 10 psi. This system could be used in real-time to monitor blast dosing across military training sites with automated reporting being delivered to Unit Commanders and Unit Clinical Staff support. Outliers in the data—e.g., high daily/hourly exposure dosing—can be made known and referred for an assessment when warranted by exposure. This evidence-based precision care may enhance mission readiness.

The sensor technology, along with audio recordings of overpressure events, was used to document that military instructors may be in the vicinity of hundreds of overpressure events per hour during training, depending on where they are situated in relation to the source of the overpressure. To identify locations with the highest blast dosing in military training, there is an opportunity for the collection of normative data using a valid system worn on the body or a well-characterized data collection point on-site, to rank-order the relative exposure dosing and identify sites that may benefit from clinical evaluation.

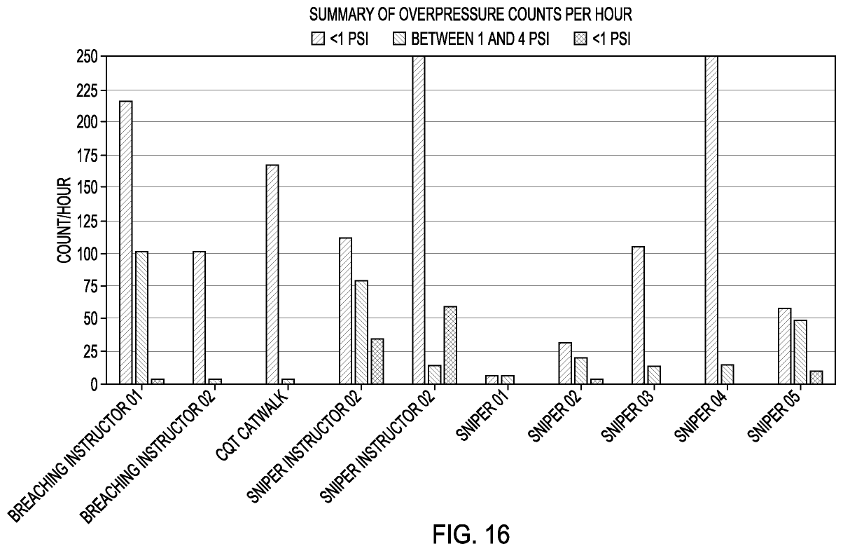

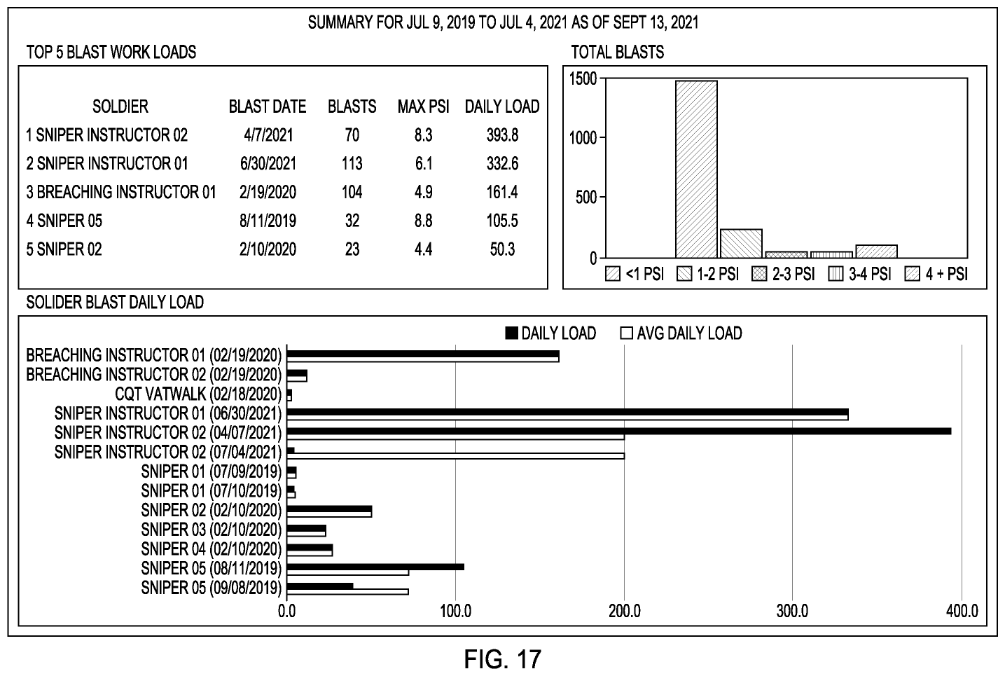

FIG. 16 is a chart of overpressure counts per hour based on a user's role/position on a shooting range, according to one or more examples and FIG. 17 is a report identifying top 5 blast work loads, total blasts, and blast daily load, according to one or more examples.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of a system may include one or more disk drives or one or more mass storage devices, one or more network ports for communicating with external devices as well as various input and output (I/O) devices, such as digital and analog general purpose I/O, a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. A system may include what is referred to as a user interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, buzzer, bell, and/or other user input/output device for communicating with one or more users or for entering information into the system. These and other devices for interacting with the system may be connected to the system through I/O device interface(s) via a system bus, but can be connected by other interfaces such as a parallel port, IEEE 1394 serial port, a game port, a USB port, an IR interface, etc. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices.

A system may also include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, I2C, SPI, USB, etc.) using any of a variety of commercially available bus architectures.

One or more programs or applications, such as a web browser and/or other executable applications, may be stored in one or more of the system data storage devices. Generally, programs may include routines, methods, data structures, other software components, etc., that perform particular tasks or implement particular abstract data types. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A user may interact with the system, programs, and data stored thereon or accessible thereto using any one or more of the input and output devices described above.

A system of the present disclosure can operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices.

Hardware and software components of the present disclosure, as discussed herein, may be integral portions of a single computer, server, controller, or message sign, or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A system for sensing and assessing blast events, the system comprising:
a sensing device configured for directly or indirectly securing to a user, the sensing device comprising:
a motion sensor configured for sensing at least one of an acceleration and a velocity associated with an event and for generating kinematic signal data based on the event;
a computer-readable storage medium having instructions stored thereon for receiving the kinematic signal data from the kinematic sensor and storing the kinematic signal data; and
a processor for processing the instructions to capture the kinematic signal data; and
a computing device configured for analyzing the kinematic signal data to classify the event as a blast event or not a blast event.

2. The system of claim 1, wherein the computing device is arranged on the sensing device.

3. The system of claim 1, wherein the computing device is physically separate from the sensing device.

4. The system of claim 1, wherein the kinematics sensor comprises a linear accelerometer having a range of 200 g and a sample rate of 3200 samples per second.

5. The system of claim 4, wherein the kinematics sensor further comprises a gyroscope.

6. The system of claim 1, wherein analyzing the kinematic sensor to classify the event as a blast event or not a blast event comprises collecting a factor from the kinematic signal data and comparing the factor to known range for the factor.

7. The system of claim 6, wherein the factor comprises a frequency and the range comprises frequencies greater than 500 Hz.

8. The system of claim 1, wherein the computing device is further configured to estimate a magnitude of the event.

9. The system of claim 1, wherein the computing device is further configured to determine a source of the event.

10. The system of claim 1, wherein the sensing device comprises a control sensor for controlling the active state of the kinematic sensor.

11. A method of assessing blast events, comprising:
sensing and recording a signal in response to an event and, using a kinematic sensor, generating a kinematic data signal; and
classifying the event as a blast event or not a blast event based on the kinematic data signal.

12. The method of claim 11, further comprising assessing the signal to determine a magnitude experienced by the user.

13. The method of claim 11, further comprising accumulating a series of events that have been classified as blast events.

14. The method of claim 11, further comprising activating a kinematic sensing device.

15. The method of claim 14, wherein activating a kinematic sensing device performed in response to a control sensor signal.

16. The method of claim 15, wherein the control sensor signal is a proximity sensor signal.

17. The method of claim 11, further comprising, filtering the kinematic data signal.

18. The method of claim 17, wherein filtering comprises filtering using a high-pass filter.

19. The method of claim 17, further comprising focusing on a relevant portion of the kinematic data signal.

20. The method of claim 11, wherein sensing and recording a signal is performed at a sample rate of 3200 samples per second.
